(19) United States
(12) Patent Application Publication
(10) Pub. No.: US 2015/0002282 A1
(43) Pub. Date: Jan. 1, 2015

(54) Sparks Theft Deterrent

(71) Applicant: Eric Francis Schnidrig, Clackamas, OR (US)

(72) Inventor: Eric Francis Schnidrig, Clackamas, OR (US)

(21) Appl. No.: 13/929,504

(22) Filed: Jun. 27, 2013

(51) Int. Cl. B60R 25/104

(52) U.S. Cl. CPC B60R 25/104
USPC 340/426.22

(57) ABSTRACT

The purpose of this invention is to prevent theft of items inside a vehicle or other devices that a thief would steal. A flashing light emitting diode (LED) is to be mounted in a prominent area inside the vehicle with double sided tape or by a hook and loop means, commonly known as Velcro™ or Scotchmate™. No drilling is needed. The LED flashes between the colors of red and blue or just red. It is NOT powered by an alarm system, it is a stand alone device.

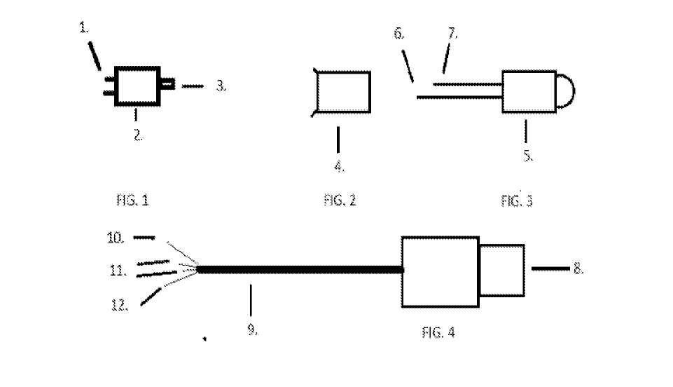

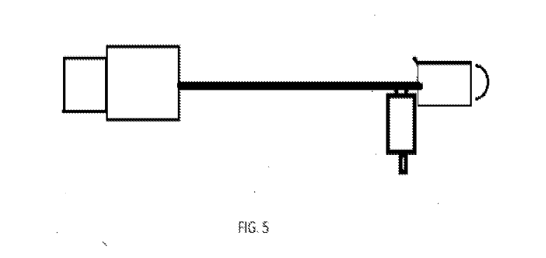

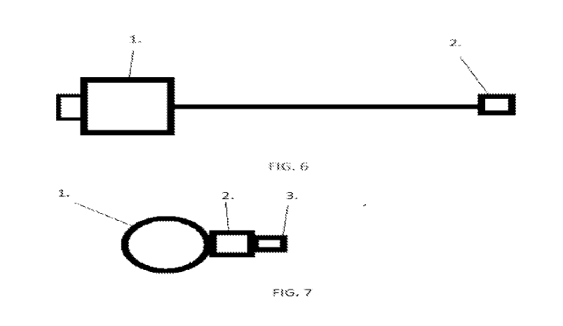

The power source for FIGS. 1, 2, 3, 4, 5, 6, is Universal Serial Bus. USB Adapters from a cigarette lighter socket or power port to USB are readily available at very low prices. (Most new vehicles have a USB port as factory equipment.)

The power source for FIG. 7 is a 3 volt, CR2032 “Coin” battery.

The consumer simply plugs it in and pushes the switch to activate it. It FIG. 7 there is no switch. It is simply plug and play.

In essence . . . It is a Fake Car Alarm. A thief would think twice about going near a vehicle with this device turned on because it is extremely bright and thieves are not.

The FIG. 7 device can be put on anything, i.e. a laptop in a coffee shop, a gym bag, etc.

The uses are enormous. The benefits are obvious, yet the financial benefit to law enforcement is tremendous!

1. The power source for FIGS. 1, 2, 3, 4, 5, 6, is Universal Serial Bus. USB Adapters from a cigarette lighter socket or power port to USB are readily available at very low prices. (Most new vehicles have a USB port as factory equipment.)
The power source for FIG. 7 is a 3 volt, CR2032 “Coin” battery.
The consumer simply plugs it in and pushes the switch to activate it. It FIG. 7 there is no switch. It is simply plug and play.
In essence . . . It is a Fake Car Alarm. A thief would think twice about going near a vehicle with this device turned on because it is extremely bright and thieves are not.
The FIG. 7 device can be put on anything, i.e. a laptop in a coffee shop, a gym bag, etc.
